(19) United States
(12) Patent Application Publication
(10) Pub. No.: US 2023/0101734 A1
(43) Pub. Date: Mar. 30, 2023

(54) MACHINE LEARNING MODEL TO FILL GAPS IN ADAPTIVE RATE SHIFTING

(71) Applicant: TrueBlue, Inc., Tacoma, WA (US)

(72) Inventors: Robert Michael Ward, Issaquah, WA (US); Christopher A. Kapcar, Hinsdale, IL (US); Carlos Lara Maldonado, Dallas, TX (US)

(21) Appl. No.: 17/934,539

(22) Filed: Sep. 22, 2022

Related U.S. Application Data
(60) Provisional application No. 63/248,423, filed on Sep. 24, 2021.

(51) Int. Cl. G06N 5/02; G06Q 10/06

(52) U.S. Cl. CPC G06N 5/022; G06Q 10/063118

(57) ABSTRACT

Disclosed is a platform that makes use of hybrid model employing both heuristic and machine learning models to adaptively generate recommendations based on requested circumstances in a temporary staffing platform. The hybrid model is based on a set of training data surrounding historical temporary staffing outcomes. The heuristic model portion identifies matches between current queries to past outcomes and the machine learning model portion trains to derive new recommendations where no match exists. Queries are received and executed upon in real-time as opposed to pre-computing based on the frequency of changes to the recommendation to what would otherwise be the same query. The hybrid model is therefore configured to optimize for real-time responses to individual queries. The data surrounding the historical temporary staffing outcomes includes data relating to users, data relating to shifts, and data derived from a combination of both.

### TECHNICAL FIELD

The disclosure relates to the training and implementation of artificial machine learning models. More particularly, the disclosure relates to filling gaps in data.

### BACKGROUND

Traditionally, temporary employment staffing systems have included branch offices where potential workers arrive early in the morning and are directed to various available temporary staffing positions for the day (e.g., event and convention workers, construction, skilled laborers, one-time projects, etc.). A given employer requests a number of workers for a task and a staffing organization fills those requests with available temporary associates.

Human assignment of temporary workers and the rates by which those workers are dispatched is often arbitrary. Writing guidance for humans is often infeasible as well because of the sheer volume of circumstances from which variance may derive. One would either have to generate far too many guidance documents such that the human could not functionally search through the guidance when needed, and/or that the documentation would require far too much maintenance. Human-driven dispatching is inefficient, often inaccurate, and suffers from relationship loss due to turnover.

### BRIEF DESCRIPTION OF THE DRAWINGS

FIG. 1 is an example of a particular embodiment of the present invention can be realized using a processing device.

FIG. 2 illustrates a networked communications system that may include the processing device.

FIG. 3 illustrates a system diagram of a system for matching workers to entities which define jobs.

FIG. 4 is a screenshot depicting a number of fields for which factors are selected to define the circumstances of a shift.

FIG. 5 is a screenshot depicting all data regarding the rate for the circumstances of a particular shift.

FIG. 6 is a screenshot depicting output of the rate for the circumstances of a particular shift.

FIG. 7 is a flowchart illustrating implementation of heuristic rate rules.

FIG. 8 is a flowchart Illustrating implementation of a machine learning model that determines output where sufficient data does not exist.

FIG. 9 is a block diagram illustrating a hybrid model.

### DETAILED DESCRIPTION

Short-term, temporary employment staffing platforms operate by linking a number of available workers to gigs (e.g., short-term, temporary employment). Available jobs are matched to workers and recommended thereto. These jobs having varying pay rates based on the skills, certifications, and/or conditions required to perform the jobs. The pay rates further vary based on the geographic region the job is performed in. These rates may be assigned by a computer-based software solution. Each job has a software assigned value put to it, so that this value is consistent. On top of a base value, various factors may be selectively applied based on circumstances of the specific job (e.g., adding or removing particular certifications).

These values are based on a set of heuristic rules using historical examples. However, because the system needs to accommodate a significant number of potential circumstances, the amount of data available to compute each circumstance via heuristics may frequently be insufficient. In such circumstances a machine learning model is implemented to generate the necessary data. The machine learning model may be implemented as any of a hidden Markov model (HMM), neural networks (NN), convolutional neural networks (CNN), or known equivalents.

A combination of models (heuristic and machine learning) is employed to address both exact or near matches to past outcomes and previously unrequested queries. Previously unrequested queries tend to be highly specific.

For example, a highly specific circumstance may include unskilled labor that is working on a construction site during second shift in rural Iowa. In that case, the platform may not have enough data to execute the heuristic rules. In such circumstances, the machine learning model may generate new data such that the heuristic rules can be executed, or simply output a solution based on learned outcomes from similar enough circumstances.

An example of how some embodiments of the machine learning model function is to identify the closest circumstance to the currently requested for which sufficient data does exist. That closest circumstance will have a number of variations from the target. For each variation, the model identifies how existence of that variation affects other circumstances (e.g., compare two circumstances that vary by a single option).

In some embodiments, the model creates new training data to support the newly requested circumstance that reflects the changes from the closest existing circumstance, to the currently requested circumstance. When new data is generated, the heuristic rules are implemented to arrive at a rate. Where new training data is not generated, the model provides the rate without the implementation of the heuristic rules.

Given enough data, either actual or fabricated, a software platform swiftly implements the heuristic rules to generate a rate for any temporary staffing circumstance that the system might handle. Heuristic rules applied, may, for example, take an upper quartile of rates used in the previous months. There can only be an upper quartile if there has been sufficient data to generate a model that has populated quartiles. Where the dispatch circumstance is highly specific such that there is not a lot of supporting data, the machine learning model will make use of data from similar circumstances and modify that data for purposes of supporting the highly specific circumstance.

Exemplary System Embodiment

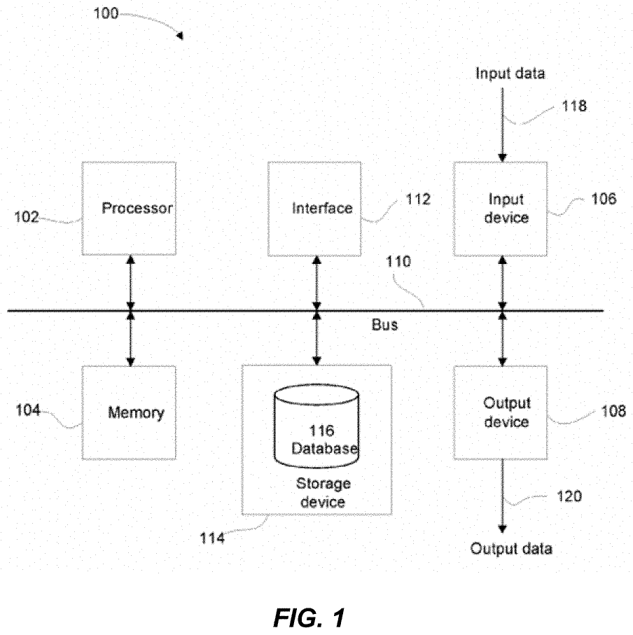

FIG. 1 is an example of a particular embodiment of the present invention can be realized using a processing device. In particular, the processing system 100 generally includes at least one processor 102, or processing unit or plurality of processors, memory 104, at least one input device 106, and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card.

At least one storage device 114 which houses at least one database 116 can also be provided. The memory 104 can be any form of memory device, for example, volatile or non-volatile memory, solid state storage devices, magnetic devices, etc. The processor 102 could include more than one distinct processing device, for example to handle different functions within the processing system 100.

In alternative embodiments, the processing system 100 operates as a standalone device or may be connected (networked) to other machines. In a networked deployment, the machine may operate in the capacity of a server or a client machine in a client-server network environment, or as a peer machine in a peer-to-peer (or distributed) network environment.

Input device 106 receives input data 118 (such as electronic content data), for example via a network or from a local storage device. Output device 108 produces or generates output data 120 (such as viewable content) and can include, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

Examples of electronic data storage devices 114 can include disk storage, optical discs, such as CD, DVD, Blu-ray Disc, flash memory/memory card (e.g., solid state semiconductor memory), MultiMedia Card, USB sticks or keys, flash drives, Secure Digital (SD) cards, microSD cards, mini SD cards, SDHC cards, mini SDSC cards, solid state drives, and the like.

In use, the processing system 100 is adapted to allow data or information to be stored in and/or retrieved from, via wired or wireless communication means, the at least one database 116. The interface 112 may allow wired and/or wireless communication between the processor 102 and peripheral components that may serve a specialized purpose. The processor 102 receives instructions as input data 118 via input device 106 and can display processed results or other output to a user by utilizing output device 108. More than one input device 106 and/or output device 108 can be provided. It should be appreciated that the processing system 100 may be any form of terminal, PC, laptop, notebook, tablet, smart phone, specialized hardware, or the like.

The machine may be a server computer, a client computer, a personal computer (PC), a tablet PC, a set-top box (STB), a personal digital assistant (PDA), a cellular telephone or smart phone, a tablet computer, a personal computer, a web appliance, a network router, switch, or bridge, or any machine capable of executing a set of instructions (sequential or otherwise) that specify actions to be taken by that machine.

While the machine-readable (storage) medium is shown in an exemplary embodiment to be a single medium, the term “machine-readable (storage) medium” should be taken to include a single medium or multiple media (a centralized or distributed database, and/or associated caches and servers) that store the one or more sets of instructions. The term “machine-readable medium” or “machine-readable storage medium” shall also be taken to include any medium that is capable of storing, encoding, or carrying a set of instructions for execution by the machine and that cause the machine to perform any one or more of the methodologies of the present invention.

In general, the routines executed to implement the embodiments of the disclosure, may be implemented as part of an operating system or a specific application, component, program, object, module, or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine or computer-readable media include, but are not limited to, recordable type media such as volatile and non-volatile memory devices, floppy and other removable disks, hard disk drives, optical disks (e.g., Compact Disk Read-Only Memory (CD ROMS), Digital Versatile Discs, (DVDs), etc.), among others, and transmission type media such as digital and analog communication links.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

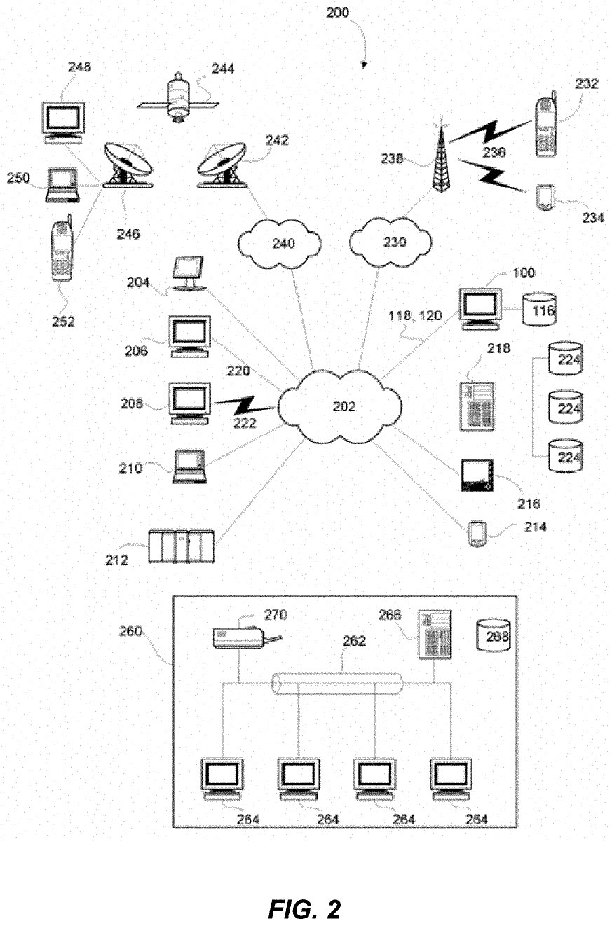

FIG. 2 illustrates a networked communications system 200 that may include the processing system 100. Processing system 100 could connect to network 202, for example the Internet or a WAN. Input data 118 and output data 120 could be communicated to other devices via network 202. Other terminals, for example, client device 204, further processing systems 206 and 208, notebook computer 210, mainframe computer 212, PDA 214, pen-based computer 216, server 218, etc., can be connected to network 202. A large variety of other types of terminals or configurations could be utilized. The transfer of information and/or data over network 202 can be achieved using wired communications means 220 or wireless communications means 222. Server 218 can facilitate the transfer of data between network 202 and one or more databases 224. Server 218 and one or more databases 224 provide an example of an information source.

Other networks may communicate with network 202. For example, telecommunications network 230 could facilitate the transfer of data between network 202 and mobile or cellular telephone 232 or a PDA-type device 234, by utilizing wireless communication means 236 and receiving/transmitting station 238. Mobile telephone 232 devices may load software (client) that communicates with a backend server 206, 212, 218 that operates a backend version of the software. The software client may also execute on other devices 204, 206, 208, and 210. Client users may come in multiple user classes such as worker users and/or employer users.

Satellite communications network 240 could communicate with satellite signal receiver 242 which receives data signals from satellite 244 which in turn is in remote communication with satellite signal transmitter 246. Terminals, for example further processing system 248, notebook computer 250, or satellite telephone 252, can thereby communicate with network 202. A local network 260, which for example may be a private network, LAN, etc., may also be connected to network 202. For example, network 202 may relate to ethernet 262 which connects terminals 264, server 266 which controls the transfer of data to and/or from database 268, and printer 270. Various other types of networks could be utilized.

The processing system 100 is adapted to communicate with other terminals, for example further processing systems 206, 208, by sending and receiving data, 118, 120, to and from the network 202, thereby facilitating possible communication with other components of the networked communications system 200.

Thus, for example, the networks 202, 230, 240 may form part of, or be connected to, the Internet, in which case, the terminals 206, 212, 218, for example, may be web servers, Internet terminals or the like. The networks 202, 230, 240, 260 may be or form part of other communication networks, such as LAN, WAN, ethernet, token ring, FDDI ring, star, etc., networks, or mobile telephone networks, such as GSM, CDMA, 3G, 4G, etc., networks, and may be wholly or partially wired, including for example optical fiber, or wireless networks, depending on a particular implementation.

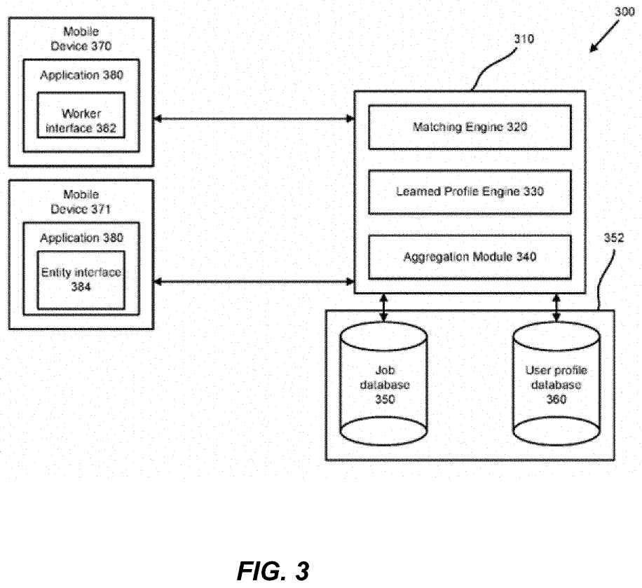

FIG. 3 illustrates a system diagram of a system 300 for pairing associates to tasks. In particular, the system 300 includes a server processing system 310 in data communication with a first and second mobile device 370, 371, preferably smart phones, or tablet processing systems, etc., via a one or more communication networks. The first mobile device 370 is operated by an associate and the second mobile device 371 is operated by a task issuer. The system 310 can include a plurality of first and second mobile devices 370, 371 operated by a respective plurality of associates and task issuers. The server processing system 310 may access or include a data store 352 including a user profile database 360 and a task database 350.

The user profile database 360 and task database 350 are configured to be hosted by the server processing system 310; however, it is equally possible that the user profile database 360 and the task database 350 are hosted by other database serving processing systems. The user profile database 360 stores the set of associate data/records used to train machine learning models such as the learned profile engine 330. The task database 360 stores the set of task data/records used to train machine learning models such as the learned profile engine 330. Processing system 100 is suitable for operation as the server processing system 310. The server processing system 310 includes a matching engine 320, a learned profile engine 330, and an aggregation module 340 which will be discussed in more detail in various examples below.

The user profile database 360 includes profiles for both workers (associates) and employers (clients). When an employer user has a service request (may be referred to as any of “task,” “job,” “shift,” or “gig”) the employer user makes use of the platform to select a job template that most closely matches the service request that they have and provides the requisite time period the service request is associated with. Worker users whom match the service request may sign up for the shift and work that service request.

The matching engine 320 is part of the machine learning models and pairs associates to job requests on an absolute or percentage confidence basis. Where a percentage basis is implemented, a threshold percentage is considered a pair that will result in an outcome of a paid/completed shift.

The mobile devices 370, 371 include a processor, a memory, an input and output device preferably provided in the form of a touch screen interface, and a communication device. Preferably, the mobile device 370, 371 includes a location receiver (such as a Global Positioning System location receiver) 375. The mobile devices 370, 371 have stored in the memory a mobile device application 380 which can be downloaded by the mobile devices 370, 371 from a software repository processing system. The user can register with the server processing system 310 as a worker or an entity. If the user registers as an associate, an associate interface 382 will be presented via the mobile application 380 via their respective mobile device 370. If the user registers as an entity, an entity interface 384 will be presented via the mobile application 380 via their respective mobile device 371. However, it will be appreciated that two separate mobile applications could be provided for the two different types of users in alternate arrangements.

Predictive Work Rate Model

Prior matching models in the temporary staffing sector seek prediction of the wrong outcome. Specifically, those models attempt to identify, given a set of tasks/shifts, which shift will the worker/associate want to agree to. A predictive work rate model instead predicts whether given a pairing of associate and shift, whether the associate will show up and work the shift.

Performing matches based on a work rate rather than associate preference enables shifting a user interface from a first come-first served model to a direct allocation model. While a predictive work rate model also supports a first-come-first served assignment model, predictive work rate also enables direct allocation. An associate preference model does not enable direct allocation. Associate preference cannot fundamentally enable direct allocation because there is no ability to sort collisions (e.g., where two associates would both have the highest preference for a given shift). Associate preference does not treat the shifts like the resource that they are. A given platform does not have unlimited available shifts, thus allocation of shifts to the associates that are most likely to show up and work the shift is more efficient.

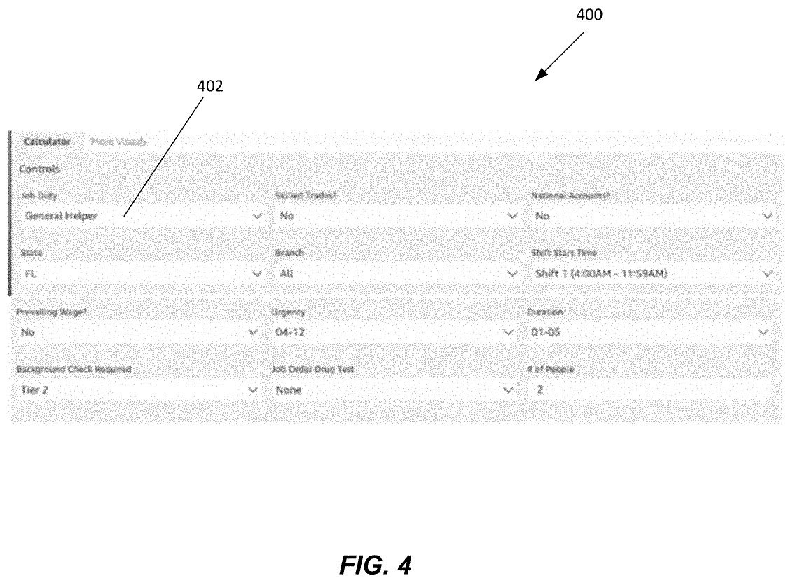

FIG. 4 is a screenshot depicting a number of fields for which factors are selected to define the circumstances of a shift. While seeking a rate for a new shift, a user identifies the set of circumstances that the shift entails via a selection menu 400. The selection menu includes a number of controls 402 that enable selection of specific circumstances. The circumstances act as filters on the existing data that may be implemented to determine a rate for the shift. As circumstances are selected, the overall data is narrowed to those instances that fit the specific circumstances.

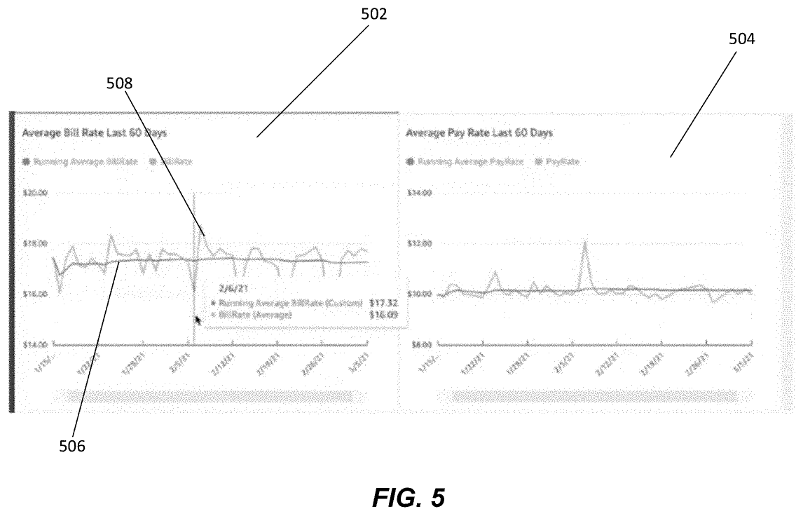

FIG. 5 is a screenshot depicting all data regarding the rate for the circumstances of a particular shift in the recent past 500. That data breaks down into billing rate data 502 and pay rate data 504. Each graph depicts an average value 506 as well as absolute data values 508. The absolute values 508 have significant variation. The variations are a result of arbitrary human decision. By application of heuristic rules, the rate calculator identifies uniform rates to apply.

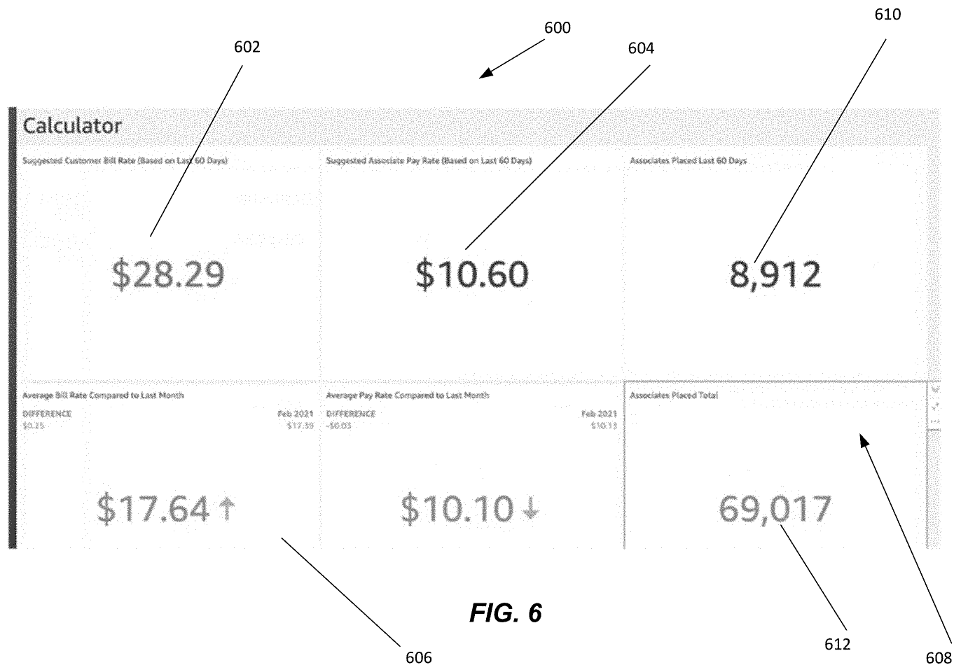

FIG. 6 is a screenshot depicting output 600 of the rate for the circumstances of a particular shift. The calculator computes an ultimate suggested bill rate 602, a suggested pay rate 604, what the respective averages are 606, and the data 608 from which the calculations are based. The data 608 can be divided into both data from all time 610, and data from the last sixty days 612. Examples of the heuristic rules implemented include a threshold applied to the quantity of the data 608. If there is not a threshold amount of data available for the specific circumstances (based on the selected filters as depicted in FIG. 4), the remaining rules do not execute.

Other rules include identifying the average of an upper quartile of data 608. In some embodiments, the data implemented is of a broader set of shift circumstances than are selected. In such embodiments, some of the selected circumstances (e.g., inclusion of a background check) apply a static adjustment to the overall rate based on geography. Thus, in some embodiments the heuristic rules do not take a raw upper quartile average to arrive at an answer.

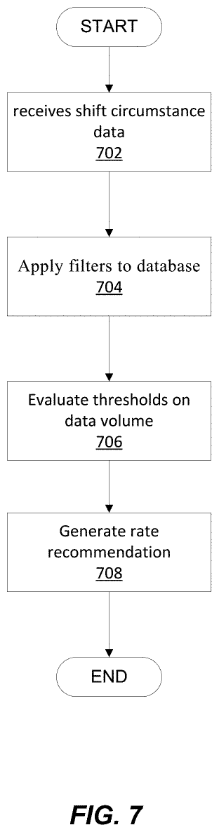

FIG. 7 is a flowchart illustrating implementation of heuristic rate rules. In step 702, the system receives input describing job circumstances. Those circumstances include details such as the type of work/skills required, where and when the job occurs, how long the job is, how many people are required, and/or whether a background check, drug test, or skill certification is required. The types of background checks or certifications may vary. The “when” of the shift may indicate a level of urgency or may indicate the day of the week.

In step 704, the system applies filters to a database to narrow the data to implement heuristic rules upon. In some embodiments, the data is narrowed by all circumstances applied in step 702. In other embodiments, the data is narrowed by a subset of the circumstances where other circumstances are used by heuristic rules to modify system output.

In step 706, the system applies a threshold to determine whether sufficient data exists based on the filtered circumstances to determine a recommended rate. The threshold may be a fixed number (e.g., 1000, 5000, or 10,000) of data items, or be based on a ratio of the total amount of data available.

In step 708, the system generates a recommended rate based on the available data. This method may be executed each time a set of circumstances are input, and for each variation to those circumstances. In some embodiments, steps are skipped in order to improve on processing efficiency (e.g., if the circumstance being modified is not one that affects the threshold of data available, step 706 need not be repeated).

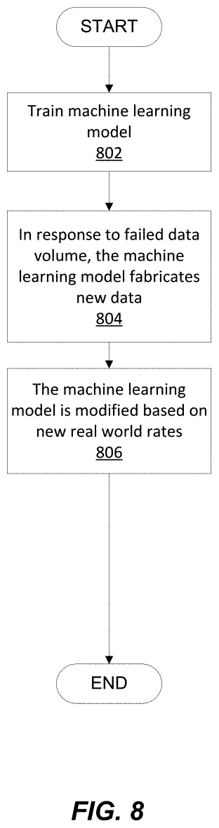

FIG. 8 is a flowchart Illustrating implementation of a machine learning model that determines output where sufficient data does not exist. In step 802, the machine learning model is trained. The training is based on the same data set that is used with the heuristic rules. The training data is all the historical data regarding rates in all geographies that data is available. The amount of training data includes hundreds of thousands of total entries. In the training process, the machine learning network builds layers of similarity between data items and links these items together. Insights the machine learning model is enabled to generate are similarities between geographies or industries as reflected in rates applied.

The learned similarities enable the machine learning model to generate new data items to fill in existing gaps. For example, the machine learning model identifies that a first geography and a second geography have similar rate implementation overall (across all other circumstances). When the data for a particular job category in the first geography is lacking, data from the second geography may be used to fabricate new data. In some embodiments the fabricated data is stored and used by the system indefinitely. In other embodiments the fabricated data is replaced as real data is collected, and/or removed from the system after a predetermined interval.

Step 804 occurs once there is a failed step 706 (e.g., not enough data is available). In step 804, the machine learning model fabricates additional data for the requested circumstances. In some embodiments, the machine learning model instead fabricates an output that modifies the output of the heuristic model.

In step 806, the machine learning model receives new training data from real world rates that were used for available shifts.

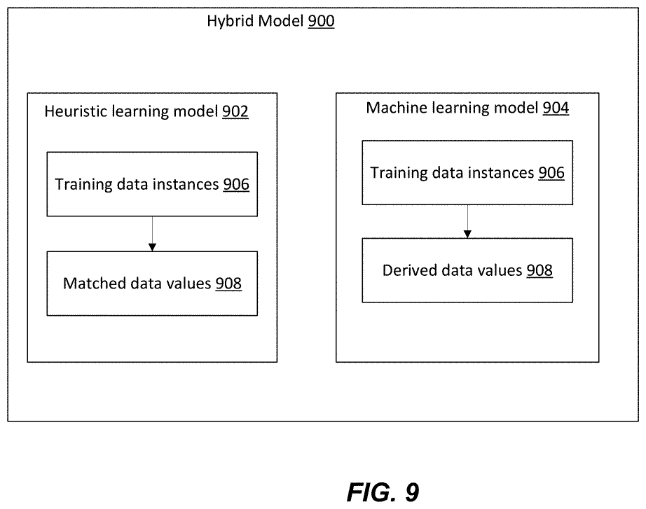

FIG. 9 is a block diagram illustrating a hybrid model 900. The hybrid model includes both a heuristic model 902 component and a machine learning model 904 component. The two components operate differently for different query types. Queries or requests of the hybrid model 900 include a configuration of a set of characteristics associated with a given task request. Some of the categories include the type of worker a requester is seeking, and where they are seeking that worker. The type of task or worker is based on a set of homogeneous categories of worker. The homogenous categories of tasks limit the amount of computation that need be down by limiting an overall n value of computations to the homogeneous categories. In some embodiments, there are roughly 20, 25, 30 such categories. Rather than include every means of describing a given task, every task serviced fits into an available category.

The geographic region further effects the value of the adaptive rate shift. Different geographies have different economics, different availabilities of workers, different laws applicable to workers and business. Some geographic regions are more similar to one another than others (e.g., rural areas tend to be like other rural areas and metropolitan areas are more like other metropolitan areas).

Other categories include a vertical serviced, a certification of the workers requested, a time period associated with performance of the task, a task site category, an identity of a requesting user, and/or a number of workers requested. A vertical refers to a service sector/trades involved with the task. For example, a given category of task (of the homogeneous categories) is a flagger. There are a number of different verticals for a flag operator—a parking director, a construction site, an airport, etc. . . .

Certifications requested include any sort of background checks or experience/safety certifications requested of the available workers. Additional certifications lead to a smaller percentage of available workers (less supply) that can be directed to the given task. A time period refers to both how long it takes to perform the given task, and how soon is the task to occur. Over some threshold length, cost increases. Cost additionally increases as the time of performance nears the time of request.

The task site category refers to whether the work site is indoors or outdoors or any other particular features of the work site (e.g., particularly hot/cold/unpleasant). The identity of the requesting user is effectively a customer ID. Where a given customer has accepted or rejected a rate for workers of a particular configuration in the past via transaction history data the model may train on that data point.

The number of workers requested influences the adaptive rates as the number of workers requested is an appreciable percentage of the available pool. Requesting all of the available workers with a given set of characteristics than leaving supply of workers for other requestors. Each prior category has a clear finite number of options. The number of workers requested doesn't theoretically have a limit. In order to put a finite number on available computations, the number of workers requested has a cap, or maximum threshold. To further reduce the n value, whatever number is used is translated into a percentage of total workers, or in percentage buckets (0-10%, 11-20%, etc. . . . ). using percentage of total worker buckets, the n value for the number of workers requested is reduced to a handful of options.

Given the query style to the hybrid model 900, one can derive the training data thereto. The training data 906 includes a large set of successful and/or failed past rates for a given set of the characteristics (or subset thereof) described above. The training data 906 is ingested by both models—heuristic 902 and machine learning 904. The heuristic model 902 sorts training data 906 into categories to perform comparisons quickly. The machine learning model 904 ingests into a data structure such as a neural network or a hidden Markov model to identify patterns within the training data 906.

Once trained, the hybrid model 900 receives requests from users on an ad hoc basis to render a value based on the query/request. Requests are performed ad hoc in order to reduce the computation required. The rates for any given configuration of the set of characteristics changes frequently (e.g., daily). Performing the analysis for every combination of the finite set of combinations available every day requires a tremendous amount of compute power; thus, the computations are performed in real-time as needed. As a result, the hybrid model 900 is structured to output single results to single queries quickly (e.g., in real-time such that an administrator can casually look up the data and use the data in conversation).

When an ad hoc request is received by the hybrid model 900, the heuristic model 902 seeks exact matches to training data. Where the heuristic model 902 has matching data, then it serves the platform to remain consistent and provide the same data. Where matching data does not exist, the query is handled by the machine learning model 904. In order to increase the speed of execution, the two models operate in parallel. The machine learning model 904 derives an adaptive rate from the training data to fill gaps.

In some embodiments the heuristic model 902 handles near matches as well via the application of heuristic rules. For example, a request that matches in every way other than the geographic location being in Seattle as opposed to a past outcome in Portland may implement a heuristic rule to equate the past outcome with the current request given the similarity in metropolitan areas with respect to temporary work. In such circumstances the machine learning model 904 is employed where the past outcomes have greater distance from the current query.

Management of the training data 906 emphasizes newer/recent results. Examples of management of training data 906 include both pruning old data (e.g., by age threshold) from the data set or decreasing a weight of that data. In some embodiments, the maintenance of the training data sets 906 for each of the two models heuristic 902 and machine learning 904 are managed differently. For example, because the heuristic model seeks exact matches, weighting the data does not change the existence of a match. Thus, deleting old data form the heuristic model 902 training data set is effective while modifying the weight of old data in the training data set of the machine learning model 904 is effective.

Training data 906 is continuously supplemented by the output of the hybrid model 900. Use of the hybrid model 900 alone generates feedback for supervised training. When a requesting user accepts the rate output or declines the rate is useful feedback for the model. In some embodiments, acceptance of a given rate is based on an occurrence of acceptance within a given time period (e.g., 30 days) from output.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps (or employ systems having blocks) in a different order, and some processes or blocks may be deleted, moved, added, subdivided, combined, and/or modified to provide sub- or alternative combinations. Each of these processes or blocks may be implemented in a variety of different ways. Also, while processes or blocks are at times shown as being performed in series, these processes or blocks may instead be performed in parallel or may be performed at different times. Further, any specific numbers noted herein are only examples; alternative implementations may employ differing values or ranges.

The teachings of the disclosure provided herein can be applied to other systems, not necessarily the system described above. The elements and acts of the various embodiments described above can be combined to provide further embodiments.

All patents, applications, and references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶6, other aspects may likewise be embodied as a means-plus-function claim, or in other forms, such as being embodied in a computer-readable medium. (Any claims intended to be treated under 35 U.S.C. § 112, ¶6 will begin with the words “means for.”) Accordingly, the applicant reserves the right to add additional claims after filing the application to pursue such additional claim forms for other aspects of the disclosure.

1. A method comprising:
generating a set of homogenous categories corresponding to a set of tasks performed by temporary workers;
training a hybrid model with training data that corresponds to each of the set of homogenous categories, the hybrid model including a heuristic model and a machine learning model, the training data including instances of dispatched workers to tasks adhering to the set of homogenous categories and described by a finite combination of a set of characteristics and a corresponding value, the set of characteristics including a first category of the set of homogenous categories and a geographic location;
receiving an ad hoc request, at the hybrid model, including a first configuration of the set of characteristics; and
dynamically computing a value responsive to the ad hoc request in real time with the ad hoc request, wherein the value is provided by the heuristic model when there is a match of the ad hoc request to the training data and derived by the machine learning model when there is no match of the ad hoc request to the training data.

2. The method of claim 1, wherein said computing is only performed in response to the ad hoc request and not computed for each of the finite combination of the set of characteristics periodically.

3. The method of claim 1, wherein the set of characteristics further includes any of:
a vertical serviced;
a number of workers requested;
a certification of the workers requested;
a time period associated with performance of the task;
a task site category; or
an identity of a requesting user.

4. The method of claim 3, wherein the set of characteristics includes the identity of the requesting user, the method further comprising:
training the hybrid model with transaction history data of the requesting user; and
modifying the value based on the transaction history data of the requesting user.

5. The method of claim 1, wherein the value includes a first value and a second value that correspond to variations in a characteristic that was not a part of the ad hoc request.

6. The method of claim 1, further including:
in response to a requesting user completing a transaction with the value, further training the hybrid model with the first configuration and the value.

7. The method of claim 1, further comprising:
in response to a requesting user declining a transaction with the value, negatively training the hybrid model with the first configuration and the value, wherein negatively training indicates to the hybrid model that a given output was incorrect.

8. The method of claim 1, further comprising:
pruning training data from the hybrid model that has reached a threshold age such that the hybrid model is trained only on instances of the training data that has not reached the threshold age.

9. The method of claim 1, further comprising:
reducing a weight of the training data from the hybrid model that has reached a threshold age such that the hybrid model is deemphasizes an impact of instances of the training data that exceeds the threshold age.

10. A system comprising:
a processor; and
a memory including instructions that when executed cause the processor to:
generate a set of homogenous categories corresponding to a set of tasks performed by temporary workers;
train a hybrid model with training data that corresponds to each of the set of homogenous categories, the hybrid model including a heuristic model and a machine learning model, the training data including instances of dispatched workers to tasks adhering to the set of homogenous categories and described by a finite combination of a set of characteristics and a corresponding value, the set of characteristics including a first category of the set of homogenous categories and a geographic location;
receiving an ad hoc request, at the hybrid model, including a first configuration of the set of characteristics; and
dynamically compute a value responsive to the ad hoc request in real time with the ad hoc request, wherein the value is provided by the heuristic model when there is a match of the ad hoc request to the training data and derived by the machine learning model when there is no match of the ad hoc request to the training data.

11. The system of claim 10, wherein said computing is only performed in response to the ad hoc request and not computed for each of the finite combination of the set of characteristics periodically.

12. The system of claim 10, wherein the set of characteristics further includes any of:
a vertical serviced;
a number of workers requested;
a certification of the workers requested;
a time period associated with performance of the task;
a task site category; or
an identity of a requesting user.

13. The system of claim 12, wherein the set of characteristics includes the identity of the requesting user, the processor further configured to:
train the hybrid model with transaction history data of the requesting user; and
modify the value based on the transaction history data of the requesting user.

14. The system of claim 10, wherein the value includes a first value and a second value that correspond to variations in a characteristic that was not a part of the ad hoc request.

15. The system of claim 10, wherein the processor is further configured to:
in response to a requesting user completing a transaction with the value, further train the hybrid model with the first configuration and the value.

16. The system of claim 10, wherein the processor is further configured to:
in response to a requesting user declining a transaction with the value, negatively train the hybrid model with the first configuration and the value, wherein negatively training indicates to the hybrid model that a given output was incorrect.

17. A non-transitory computer-readable medium having executable instructions stored thereon that when executed by one or more processors, configure the one or more processors to perform operations of:
generate a set of homogenous categories corresponding to a set of tasks performed by temporary workers;
train a hybrid model with training data that corresponds to each of the set of homogenous categories, the hybrid model including a heuristic model and a machine learning model, the training data including instances of dispatched workers to tasks adhering to the set of homogenous categories and described by a finite combination of a set of characteristics and a corresponding value, the set of characteristics including a first category of the set of homogenous categories and a geographic location;
receiving an ad hoc request, at the hybrid model, including a first configuration of the set of characteristics; and
dynamically compute a value responsive to the ad hoc request in real time with the ad hoc request, wherein the value is provided by the heuristic model when there is a match of the ad hoc request to the training data and derived by the machine learning model when there is no match of the ad hoc request to the training data.

18. The non-transitory computer-readable medium of claim 17, wherein said dynamic computing is only performed in response to the ad hoc request and not computed for each of the finite combination of the set of characteristics periodically.

19. The non-transitory computer-readable medium of claim 17, wherein the set of characteristics further includes any of:
a vertical serviced;
a number of workers requested;
a certification of the workers requested;
a time period associated with performance of the task;
a task site category; or
an identity of a requesting user.

20. The non-transitory computer-readable medium of claim 19, wherein the set of characteristics includes the identity of the requesting user, wherein the executable instructions, upon execution, further configure the one or more processors to:
train the hybrid model with transaction history data of the requesting user; and
modify the value based on the transaction history data of the requesting user.

21. The non-transitory computer-readable medium of claim 17, wherein the value includes a first value and a second value that correspond to variations in a characteristic that was not a part of the ad hoc request.
